(19) United States
(12) Patent Application Publication
(10) Pub. No.: US 2026/0257692 A1
(43) Pub. Date: Sep. 3, 2026

(54) VEHICLE CONTROL APPARATUS, VEHICLE CONTROL METHOD, AND NON-TRANSITORY COMPUTER-READABLE STORAGE MEDIUM STORING PROGRAM

(71) Applicant: TOYOTA JIDOSHA KABUSHIKI KAISHA, Toyota-shi (JP)

(72) Inventors: Hiroki YABUSHITA, Toyota-shi (JP); Hirotaka HATAKEYAMA, Nagoya-shi (JP)

(73) Assignee: TOYOTA JIDOSHA KABUSHIKI KAISHA, Toyota-shi (JP)

(21) Appl. No.: 19/434,833

(22) Filed: Dec. 29, 2025

(30) Foreign Application Priority Data
Feb. 28, 2025 (JP) 2025-031551

(51) Int. Cl. B60W 50/14; B60K 35/26; B60K 35/28; B60W 30/095

(52) U.S. Cl. CPC B60W 50/14; B60K 35/26; B60K 35/28; B60W 30/0956; B60K 2360/178; B60K 2360/1868; B60W 2050/143; B60W 2050/146

(57) ABSTRACT

The vehicle control apparatus comprises: a warning device including a warning display device configured to display a warning to a user of a vehicle; and a controller configured to cause the warning display device to start displaying the warning when it is determined that a collision risk object that has a possibility of colliding with the vehicle is present. The controller is configured to continue displaying the warning, during a period in which the collision risk object is present, until a specific operation execution time point when the user performs a specific driving operation after visually recognizing the displayed warning, and to terminate the display of the warning at the specific operation execution time point.

### TECHNICAL FIELD

The present invention pertains to a vehicle control apparatus, a vehicle control method, and a non-transitory computer-readable storage medium storing a program for providing a warning to a vehicle user for reducing a risk of collision.

### BACKGROUND

One of the conventional apparatuses of this kind (hereinafter, simply referred to as a “conventional apparatus”) is configured to erase an image displayed on a screen of a display, when it determines that the user of the vehicle (i.e., the driver) continuously looks at the screen for a predetermined period of time (refer to Japanese Patent Application Laid-Open No. 2002-274218).

### SUMMARY

In a case in which a warning to reduce the risk of collision is displayed on the display screen, the driver may not recognize the risk of collision even if the driver continuously looks at the display screen for a predetermined period of time. Accordingly, as in the conventional apparatus, if the warning is erased when the driver continuously looks at the warning for a predetermined period of time, the driver may not perform an appropriate driving operation to reduce the risk of collision.

On the other hand, when the warning continues to be displayed, the driver is likely to continuously look at the warning. Therefore, the driver may fail to sufficiently observe an object having the risk of collision (hereinafter referred to as a “collision risk object”) and the surrounding circumstances of the vehicle. Accordingly, it is also undesirable to continue displaying the warning.

The present disclosure has been made to solve the above-described problems. That is, one of the objects of the present disclosure is to provide a vehicle control apparatus, a vehicle control method, and a non-transitory computer-readable storage medium storing a program therefor, which are configured to appropriately terminate the display of the warning regarding the collision risk object at a more appropriate timing.

One aspect of the vehicle control apparatus according to the present disclosure comprises:

a warning device (WD) including a warning display device (61) configured to display a warning to a user of a vehicle; and

a controller (10) configured to cause the warning display device to start displaying the warning (S230) when it is determined that a collision risk object that has a possibility of colliding with the vehicle is present (S210).

The controller (10) is further configured to delay a timing to terminate the display of the warning (S430, S450) when the user does not perform a specific driving operation to reduce the collision risk (S420: Yes, S430: No) after visually recognizing the displayed warning (XR(n)=1), as compared with a case where the user performs the specific driving operation (S420: Yes, S430: Yes) after visually recognizing the displayed warning (XR(n)=1).

According to this aspect, the timing to terminate (or stop) the display of the warning is delayed when the user does not perform the specific driving operation to reduce the collision risk after visually recognizing the displayed warning, as compared with the case where the user performs the specific driving operation after visually recognizing the displayed warning. Thus, the apparatus enables the user to appropriately recognize the meaning of the warning. In addition, when the user performs the specific driving operation after visually recognizing the displayed warning, the display of the warning is terminated relatively earlier. Therefore, a situation in which the warning unnecessarily continues to be displayed for a relatively long time can be avoided. Accordingly, the apparatus enables the user to perform the specific driving operation while causing the user to reliably recognize the collision risk object and the surrounding circumstances of the vehicle.

In one of the aspects, the controller is configured, in a period in which the collision risk object is present, to continue displaying the warning until a specific operation execution time point at which the user performs the specific driving operation after visually recognizing the displayed warning, and to terminate the display of the warning at the specific operation execution time point (S210: No, S250, S410 – S450).

According to the above-described aspect, the display of the warning is terminated (or stopped) at the specific operation execution time point at which the user performs the specific driving operation after visually recognizing the displayed warning. Therefore, the display of the warning can be terminated relatively earlier. As a result, the apparatus enables the user to perform the specific driving operation while causing the user to more reliably recognize the collision risk object and the surrounding circumstances of the vehicle.

In one of the aspects,

the warning device (WD) includes a warning sound generating device (62) configured to generate a warning sound, and

the controller (10) is configured to:

cause the warning sound generating device to start generating the warning sound when it is determined that the collision risk object is present (S210: Yes, S230); and

cause the warning sound generating device to continue generating the warning sound regardless of whether or not the user performs the specific driving operation, as long as the collision risk object is present (S510, S250).

According to the above-described aspect, the display of the warning is terminated (or stopped) at the specific operation execution time point at which the user performs the specific driving operation after visually recognizing the displayed warning, whereas the warning sound continues to be generated until the collision risk object no longer exists. Therefore, the apparatus enables the user to more reliably continue the specific driving operation.

Notably, in the above description, in order to facilitate understanding of the present disclosure, the constituent elements corresponding to those of an embodiment which will be described later are accompanied by parenthesized symbols and/or names which are used in the embodiment; however, the constituent elements of the disclosure are not limited to those in the embodiment defined by the symbols and/or names. The present disclosure also covers a vehicle control method, and a non-transitory computer-readable storage medium having stored therein a program that causes a computer mounted on the vehicle to execute steps in the vehicle control method.

### BRIEF DESCRIPTION OF THE DRAWINGS

FIG. 1 is a schematic diagram of a vehicle control apparatus according to an embodiment of the present disclosure.

FIG. 2 shows a routine executed by a CPU of the vehicle control ECU shown in FIG. 1.

FIG. 3 shows a routine executed by the CPU of the vehicle control ECU shown in FIG. 1.

FIG. 4 shows a routine executed by the CPU of the vehicle control ECU shown in FIG. 1.

FIG. 5 shows a routine executed by a CPU of the vehicle control ECU according to the modified embodiment of the present disclosure.

### DETAILED DESCRIPTION

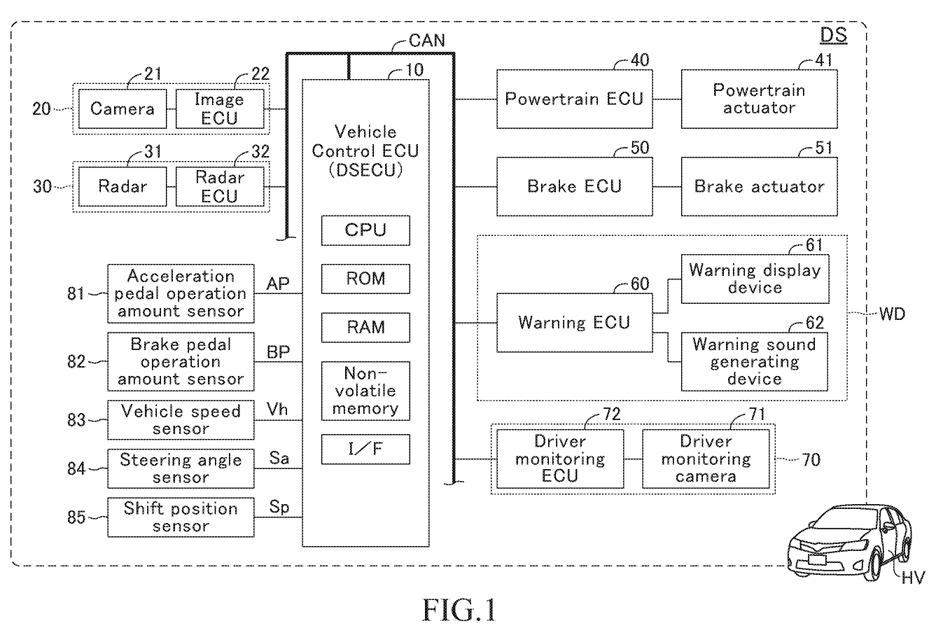

A vehicle control apparatus (hereinafter, referred to as an "apparatus DS") according to an embodiment of the present disclosure comprises the elements (components) shown in FIG. 1. The apparatus DS is applied to (i.e., is mounted on) a vehicle HV. The vehicle HV may be any type of vehicle including a vehicle powered by an internal combustion engine, an electric vehicle, or a hybrid vehicle.

In the present specification, an ECU refers to an electronic control device/unit comprising a microcomputer which includes a CPU (i.e., a processor), a ROM, and a RAM. The ECU may also be referred to as a controller or a computer. A plurality of ECUs illustrated in FIG. 1 are connected to each other via a Controller Area Network (CAN) so as to be able to exchange data. All or some of the ECUs may be integrated into a single ECU.

The vehicle control ECU 10 is configured to transmit signals to and receive signals from the elements (components) illustrated in FIG. 1. The vehicle control ECU 10 is also referred to as a “driver assistance ECU”. The vehicle control ECU 10 is configured to provide a warning (i.e., to display a warning and to generate a warning sound) to reduce the possibility that the vehicle HV collides with an object. The possibility that the vehicle HV collides with an object is also referred to as a “collision risk”.

The camera device 20 includes a camera 21 and an image ECU 22. The camera 21 is configured to capture an image of a scene ahead of the vehicle HV to obtain image data representing the captured scene, every time a predetermined time elapses. The image ECU 22 is configured to produce camera object information based on the image data. The camera object information includes “a position (a longitudinal position and a lateral position) and a type” of an object located ahead of the host vehicle.

The radar device 30 is a well-known device configured to obtain information on an object located ahead of the vehicle HV, using electromagnetic waves in a millimeter-wave band. The radar device 30 includes a radar 31 and a radar ECU 32. The radar 31 is configured to emit the electromagnetic waves within a detection area and to receive the electromagnetic waves that are reflected from an object every time a predetermined time elapses. The radar ECU 32 obtains radar object information based on the electromagnetic waves that are emitted and received by the radar 31. The radar object information includes a distance to an object, an azimuth of the object, and a relative (longitudinal) speed of the object.

The vehicle control ECU 10 generates final object information (i.e., fusion object information) by fusing the camera object information with the radar object information. Therefore, the camera device 20 and the radar device 30 constitute an object information acquiring device configured to obtain vehicle surrounding information regarding surroundings (such as an object and a road sign) ahead of the vehicle HV. The fusion object information is also referred to as frontward object information. It should be noted that the image ECU 22 or the radar ECU 32 may be configured to generate the fusion object information and transmit it to the vehicle control ECU 10.

The powertrain ECU 40 is configured to adjust a driving force of the vehicle HV generated by an unillustrated driving device of the vehicle HV by controlling the powertrain actuator 41 in accordance with an instruction from the vehicle control ECU 10 or an operation of an accelerator pedal by a user (e.g., a driver in a driver’s seat) of the vehicle HV. The driving device includes a driving source (e.g., an internal combustion engine and/or an electric motor) and a power transmitting device (e.g., a transmission).

The brake ECU 50 is configured to adjust a braking force generated by an unillustrated brake device of the vehicle HV by controlling the brake actuator 51 in accordance with an instruction from the vehicle control ECU 10 or an operation of a brake pedal by the user (e.g., the driver) of the vehicle HV. Therefore, the brake ECU 50 can control a deceleration of the vehicle HV.

The warning (or alert) ECU 60 constitutes a warning (or alert) device (WD) together with the warning display device 61 and the warning sound generating device 62. The warning ECU 60 is configured to cause the warning display device 61 to display a predetermined warning (e.g., a warning image, a warning sign, or a warning lamp) and to cause the warning sound generating device 62 to generate the warning sound, in accordance with an instruction from the vehicle control ECU 10. The warning display device 61 is configured to display the warning at a position where the user (e.g., the driver) of the vehicle HV can visually recognize it. The warning display device 61 may be any one of a conventional display, a display device incorporated in an instrument panel, or a head-up display.

The driver monitoring device (driver monitor) 70 is a device configured to obtain driver information which is information indicative of a condition or state of the driver that is a user of the vehicle HV. The driver information includes a line-of-sight direction of the driver. The driver monitoring device 70 includes the driver monitoring camera 71 and the driver monitoring ECU 72, and is disclosed, for example, in Japanese Patent Application Laid-Open No. 2019-87029, Japanese Patent Application Laid-Open No. 2013-152700, and so forth.

The driver monitoring camera 71 is configured to generate face image data by capturing an image of a face of the driver, including eyes, of the host vehicle every time a predetermined time elapses. The driver monitoring ECU 72 is configured to obtain the driver information based on the face image data transmitted from the driver monitoring camera 71, and to transmit the driver information to the vehicle control ECU 10.

The vehicle control ECU 10 is configured to receive a detection value or an output value of sensors described below.

The acceleration pedal operation amount sensor 81, which is configured to detect an acceleration pedal operation amount AP of an unillustrated accelerator pedal of the vehicle HV.

The brake pedal operation amount sensor 82, which is configured to detect a brake pedal operation amount BP of an unillustrated brake pedal of the vehicle HV.

The vehicle speed sensor 83, which is configured to detect a speed (i.e., vehicle speed) Vh of the vehicle HV.

The steering angle sensor 84, which is configured to detect a steering angle Sa of the vehicle HV.

The shift position sensor 85, which is configured to detect a shift position Sp of the driving device of the vehicle HV.

### Outline of operation

The apparatus DS is configured to determine whether an object having a collision risk (i.e., a collision risk object) is present ahead of the vehicle HV based on the fusion object information. When the apparatus DS determines that the collision risk object is present ahead of the vehicle HV, it provides a warning to notify the user of the vehicle HV (e.g., the driver) of the presence of the collision risk object. This warning includes displaying a warning (e.g., a warning image, a warning lamp, and so forth) using the warning display device 61 and generating a warning sound (e.g., a buzzer, a voice message, and so forth) using the warning sound generating device 62.

If the warning continues to be displayed while the collision risk object is present, there is a high possibility that the user (e.g., the driver) of the vehicle HV continues to look at the displayed warning, and/or the frequency with which the user looks at the displayed warning may increase. As a result, there may be a case in which the user of the vehicle HV fails to sufficiently observe “the collision risk object, the surrounding circumstances of the vehicle HV, and so forth” that should be carefully watched. In view of the above, it may be appropriate to stop displaying the warning when the line of sight of the driver has been directed toward the displayed warning for a period equal to or longer than a time threshold.

However, even when the user of the vehicle (e.g., the driver) continues to direct his or her line of sight toward the displayed warning for a time period equal to or longer than a threshold value, the user does not necessarily grasp or recognize the meaning of the warning. Therefore, if displaying the warning is stopped when the driver’s line of sight has been directed toward the displayed warning for a time period equal to or longer than a threshold value, the user may fail to perform an appropriate driving operation to reduce the collision risk. It is to be noted that an appropriate driving operation to reduce the collision risk is also referred to as a “specific driving operation”.

In view of the above, the apparatus DS is configured to terminate the display of the warning (i.e., to stop displaying the warning) after the display of the warning has been started, when both a first condition and a second condition described below are satisfied. The first condition is a condition which is satisfied when the user visually recognizes (i.e., looks at) the display after the display of the warning has been started. The second condition is a condition which is satisfied when the user starts a specific driving operation for reducing the collision risk after the user visually recognizes the display. In other words, the apparatus is configured to lengthen a period during which the warning is displayed by delaying the timing to terminate/stop the warning (e.g., at least the display of the warning) when the first condition is satisfied but the second condition is not satisfied as compared with a case where both the first condition and the second condition are satisfied. This enables the apparatus DS to stop displaying the warning at a more appropriate time. It is to be noted that the first condition may be a condition which is satisfied when the user visually recognizes (i.e., looks at) the display for a period equal to or longer than a threshold time after the display of the warning is started.

### Specific operation

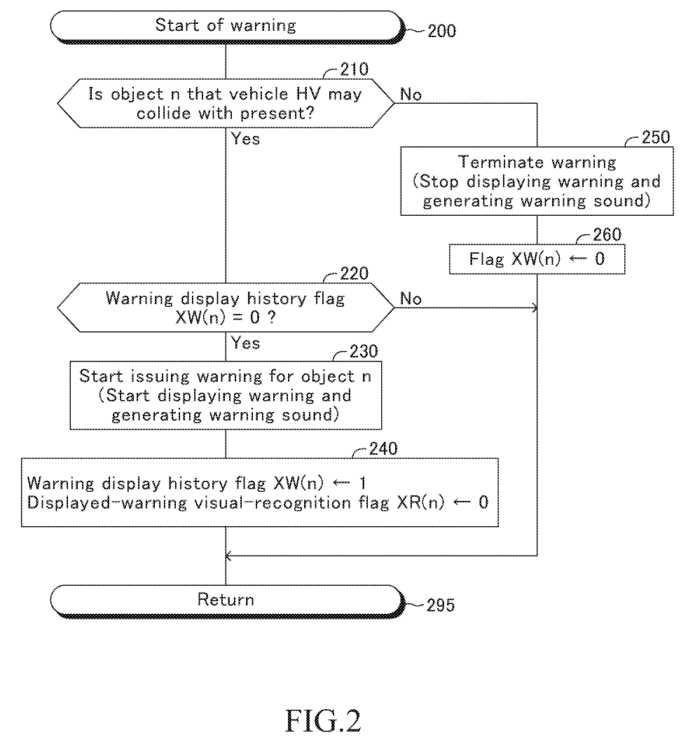

The CPU of the vehicle control ECU 10 executes routines illustrated in FIGS. 2 - 4, every time a predetermined time elapses. In the following description, “step” is denoted by “S”.

### Start of warning

At an appropriate time, the CPU starts processing from S200 shown in FIG. 2, and proceeds to S210. At step S210, the CPU determines, based on the fusion object information, whether an object n (i.e., a collision risk object n) that the vehicle HV may collide with (i.e., an object having a collision risk) is present ahead of the vehicle HV. The object n having a collision risk (i.e., the collision risk object n) refers to an object whose probability of collision with the vehicle HV exceeds a threshold value in a case where the vehicle HV keeps its current driving condition. The collision risk object n may be regarded as an object that should be watched or recognized by the user (e.g., the driver) of the vehicle HV.

For example, the CPU determines whether an object n is present in an area (i.e., a vehicle traveling area) through which the vehicle HV will pass in a case where the vehicle HV keeps the current vehicle speed Vh and the current moving direction for a predetermined time. Thereafter, when the CPU determines that the object n is present in the vehicle traveling area, the CPU calculates a time to collision TTC which is a time length until the vehicle HV collides with the object n. The time to collision TTC is calculated by dividing a distance (i.e., a longitudinal distance) between the vehicle HV and the object n by the relative speed (i.e., the longitudinal relative speed) of the object n. When the time to collision TTC becomes equal to or shorter than a time threshold TTCth, the CPU determines that the object n has the collision risk. It should be noted that a method for determining whether a collision risk object n is present is not limited to the above-described method. For example, the CPU may determine that a collision risk object n is present when an object n is present within a predetermined warning area ahead of the vehicle HV. A longitudinal length of the predetermined warning area may become longer as the longitudinal relative speed along the traveling direction of the vehicle HV of the object n with respect to the vehicle HV becomes higher. A lateral length of the predetermined warning area may become longer as the lateral relative speed of the object n with respect to the vehicle HV along a direction orthogonal to the traveling direction of the vehicle HV becomes higher.

When the CPU determines that the collision risk object n is present, the CPU proceeds from S210 to S220. At S220, the CPU determines whether a value of a warning display history flag XW(n) corresponding to the object n is “0”. When the value of the warning display history flag XW(n) is “1”, the warning display history flag XW(n) indicates that the warning including the display of the warning for the object n has been issued. When the value of the warning display history flag XW(n) is “0”, the warning display history flag XW(n) indicates that the warning for the object n has not yet been issued.

It should be noted that the values of the warning display history flag XW(n), a displayed-warning visual-recognition flag XR(n), and so forth are set to “0” through an initialization routine executed by the CPU when an unillustrated start switch (e.g., an ignition switch or a ready switch) of the vehicle HV is switched from an off position to an on position.

When the value of the warning display history flag XW(n) is “0”, the CPU proceeds from S220 to S230 to start issuing (performing) the warning for the object n. That is, the CPU starts “displaying the warning using the warning display device 61 and generating the warning sound using the warning sound generating device 62” to notify or warn the user (i.e., the driver) of the vehicle HV of the presence of the collision risk object n.

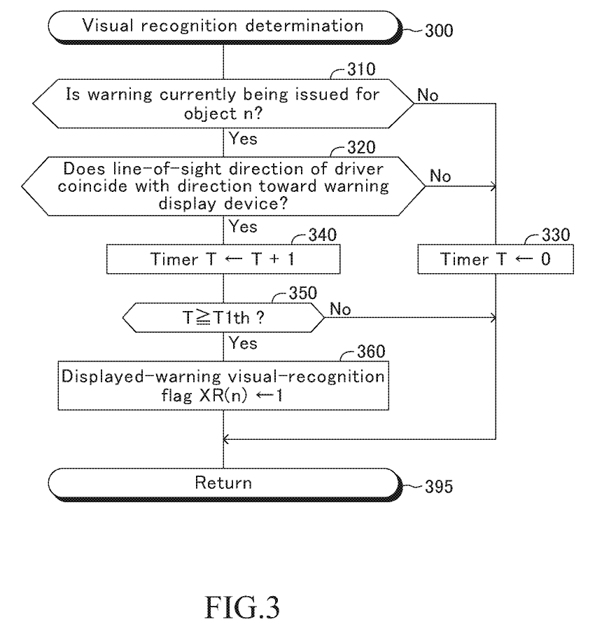

Next, the CPU proceeds to S240. At S240, the CPU sets the value of the warning display history flag XW(n) to “1” and sets the value of the displayed-warning visual-recognition flag XR(n) to “0”. Thereafter, the CPU proceeds to S295 to terminate the present routine tentatively. When the value of the displayed-warning visual-recognition flag XR(n) is “1”, the displayed-warning visual-recognition flag XR(n) indicates that the time period (or duration) during which the line-of-sight direction of the driver coincides with a direction toward the warning display device 61 is equal to or longer than a visual recognition time threshold T1th (refer to S360 shown in FIG. 3). In other words, when the value of the displayed-warning visual-recognition flag XR(n) is “1”, the displayed-warning visual-recognition flag XR(n) indicates that there is a record indicating that the driver has visually recognized the warning for the object n.

In a case where the collision risk object n is not present when the CPU proceeds to step S210, the CPU proceeds from step S210 to step S250. At S250, the CPU stops (i.e., terminates) the warning if the warning is currently being issued. That is, the warning is issued only in a period in which the collision risk object n is present. Subsequently, the CPU proceeds to S260 to set the value of the warning display history flag XW(n) to “0” and then directly proceeds to S295 to terminate the present routine tentatively.

In addition, in a case where the value of the warning display history flag XW(n) is “1” (i.e., the warning for the object n has already been issued) when the CPU proceeds to S220, the CPU directly proceeds from S220 to S295 to terminate the present routine tentatively.

### Visual recognition determination

At an appropriate time, the CPU starts processing from S300 shown in FIG. 3 and proceeds to S310. At step S310, the CPU determines whether the CPU is currently issuing (performing) the warning for the object n. When the CPU is currently issuing the warning for the object n, the CPU proceeds from S310 to S320. At S320, the CPU obtains information indicative of the line-of-sight of the driver from the driver monitoring ECU 72 and determines, based on the information, whether the line-of-sight direction of the driver coincides with the direction toward the warning display device 61. That is, the CPU determines whether the driver is looking at (i.e., visually recognizing) the displayed warning.

When the line-of-sight direction of the driver does not coincide with the direction toward the warning display device 61, the CPU proceeds from S320 to S330 to set a value of the timer T to “0”. Thereafter, the CPU directly proceeds to S395 to terminate the present routine tentatively.

Whereas, when the line-of-sight direction of the driver coincides with the direction toward the warning display device 61, the CPU proceeds from S320 to S340 to increase the value of the timer T by “1”. Subsequently, the CPU proceeds to S350 to determine whether the value of the timer T is equal to or greater than the visual recognition time threshold T1th. It should be noted that the visual recognition time threshold T1th is equal to or greater than “1”. When the visual recognition time threshold T1th is set to a value equal to “1”, the determination condition in S350 becomes satisfied when the line-of-sight direction of the driver starts directing toward the warning display device 61. When the visual recognition time threshold T1th is set to a value greater than “1”, the determination condition in S350 becomes satisfied when the line-of-sight direction of the driver continues be directed toward the warning display device 61 for a predetermined time that corresponds to the visual recognition time threshold T1th.

When the value of the timer T is less than the visual recognition time threshold T1th, the CPU directly proceeds from S350 to S395.

In contrast, when the value of the timer T is equal to or greater than the visual recognition time threshold T1th, the CPU determines that the above-described first condition becomes satisfied so as to proceed from S350 to S360. At S360, the CPU sets the value of the displayed-warning visual-recognition flag XR(n) to “1”. Thereafter, the CPU proceeds to S395.

It should be noted that if the CPU is not currently issuing the warning for the object n when the CPU proceeds to S310, the CPU proceeds to S395 via S330.

### Termination of warning

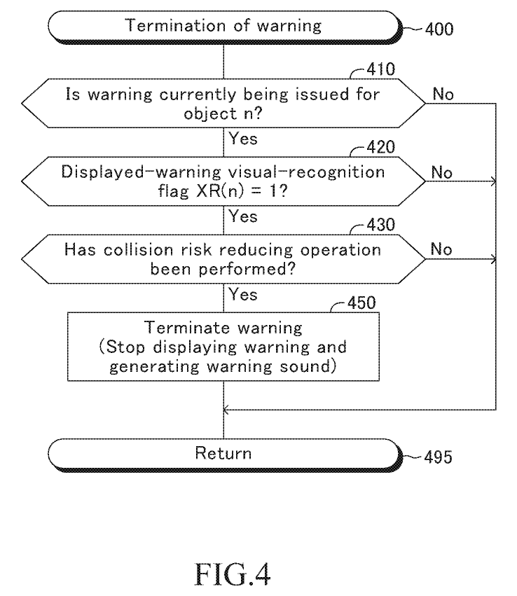

At an appropriate time, the CPU starts processing from S400 shown in FIG. 4 and proceeds to S410. At step S410, the CPU determines whether the CPU is currently issuing (performing) the warning for the object n. When the CPU is not currently issuing the warning for the object n, the CPU directly proceeds from S410 to S495 to terminate the present routine tentatively.

Whereas, when the CPU is currently issuing the warning for the object n, the CPU proceeds from S410 to S420 to determine whether the value of the displayed-warning visual-recognition flag XR(n) is “1”. When the value of the displayed-warning visual-recognition flag XR(n) is not “1”, the CPU directly proceeds from S420 to S495 to terminate the present routine tentatively.

In contrast, when the value of the displayed-warning visual-recognition flag XR(n) is “1”, the CPU proceeds from S420 to S430 to determine whether the driver has performed a driving operation (i.e., a specific driving operation) to reduce the collision risk with respect to the object n. The specific driving operation may sometimes be referred to as a “collision risk reducing operation”.

Specifically, the CPU determines that the driver has performed the specific driving operation when at least one of the following driving operations (1) to (4) is performed. It should be noted that, hereinafter, a time point at which the value of the displayed-warning visual-recognition flag XR(n) changes from “0” to “1” is also referred to as a “displayed-warning visual-recognition time point”. The specific driving operation is not limited to the following driving operations 1 to 4. The specific driving operation may be determined to have been performed when, for example, a magnitude of deceleration of the vehicle HV becomes equal to or greater than a magnitude of a certain deceleration expected when a strong braking operation is performed.

(Driving operation 1) An operation (i.e., a brake pedal pressing operation) to change the brake pedal operation amount BP to a value greater than the brake pedal operation amount at the displayed-warning visual-recognition time point.

(Driving operation 2) An operation (i.e., a strong braking operation) to keep the brake pedal operation amount BP, for a predetermined time or longer, at a value equal to or greater than a brake operation amount threshold BPth to perform a predetermined strong braking.

(Driving operation 3) An operation (i.e., a downshift operation) to downshift after the displayed-warning visual-recognition time point. The downshift operation refers to an operation that increases the gear ratio (specifically, the final gear ratio) by at least a predetermined value. Whether the downshift is performed is determined, for example, based on the output signal of the shift position sensor 85.

(Driving operation 4) An operation (i.e., a collision avoidance steering operation) to change the steering angle St from the steering angle at the displayed-warning visual-recognition time point to a steering angle that changes the traveling direction of the vehicle HV to a direction to avoid the collision with the object n.

When the specific driving operation to reduce the collision risk with respect to the object n is not performed, the CPU directly proceeds from S430 to S495 to terminate the present routine tentatively. In this case, the warning is continued.

In contrast, when the specific driving operation to reduce the collision risk with respect to the object n is performed, the CPU proceeds from S430 to S450 to terminate the warning (i.e., to stop displaying the warning and generating the warning sound). Thereafter, the CPU proceeds to S495.

As has been described, the apparatus DS is configured to lengthen a period during which the warning is displayed by delaying a timing to terminate (or stop) the warning when the user (e.g., the driver) merely visually recognizes the displayed warning but does not perform the specific driving operation to reduce the collision risk, compared with a case where the user performs the specific driving operation after the user visually recognizes the displayed warning. Accordingly, the apparatus DS enables the user to reliably recognize the meaning of the warning. In addition, the apparatus DS terminates (or stops) the warning relatively early when the user performs the specific driving operation after visually recognizing the displayed warning. Therefore, a case in which the warning unnecessarily continues to be displayed for a relatively long time can be avoided. As a result, the apparatus DS enables the user to perform the specific driving operation while causing the user to reliably recognize the collision risk object and the surrounding circumstances of the vehicle.

### Modification

The modified apparatus corresponding to the apparatus DS according to the embodiment of the present disclosure is different from the apparatus DS only in that the modified apparatus is configured to continue generating the warning sound until the collision risk object n is no longer present while terminating the display of the warning when the above-described first conditions 1 and 2 are both satisfied.

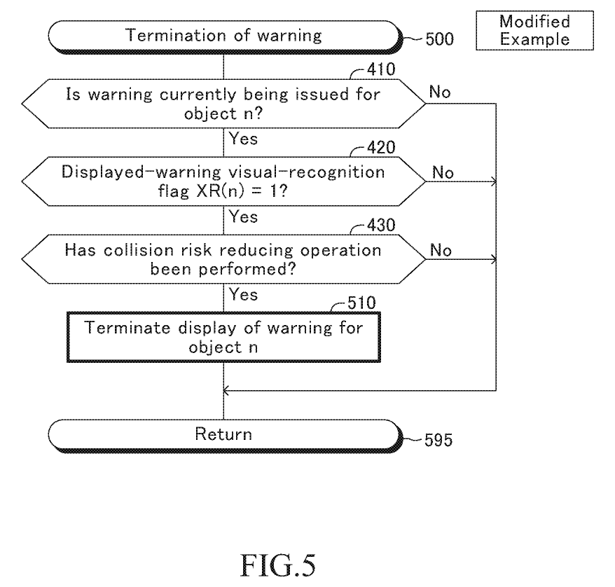

More specifically, the CPU of the vehicle control ECU of the modified apparatus executes a routine shown using a flowchart of FIG. 5 in place of FIG. 4, every time a predetermined time elapses. The routine shown in FIG. 5 is the same as the routine shown in FIG. 4 except that S450 is replaced with S510. The steps in FIG. 5 are the same as the steps in FIG. 4 except for S510. At S510, the CPU terminates (or stops) the display of the warning for the object n, but does not stop generating the warning sound. In this case, generating the warning sound is terminated when the collision risk object n is no longer present, in S250 shown in FIG. 2.

According to the modified apparatus, displaying the warning with respect to the collision risk object n is terminated at the timing (i.e., the specific operation execution time point) when the user (e.g., the driver) performs the above-described specific driving operation after visually recognizing the displayed warning with respect to the collision risk object n, but the warning sound continues to be generated until that collision risk object n becomes no longer present. Therefore, the modified apparatus enables the user to reliably continue performing the specific driving operation.

The present disclosure is not limited to the above-described embodiment and the modification, and can adopt various modifications within the scope of the present disclosure. For example, the present disclosure can be applied to an autonomous driving vehicle in a state where a driving mode has been transitioned from autonomous driving to manual driving by the driver. Furthermore, the object information acquiring device may be configured to include either the camera device 20 only or the radar device 30 only. The object information acquiring device may also be configured to include a LiDAR device.

What is claimed is:

1. A vehicle control apparatus comprising:
a warning device including a warning display device configured to display a warning to a user of a vehicle; and
a controller configured to cause said warning display device to start displaying said warning when it is determined that a collision risk object that has a possibility of colliding with said vehicle is present;
wherein said controller is configured to delay a timing to terminate the display of said warning when said user does not perform a specific driving operation to reduce said collision risk after visually recognizing said displayed warning, as compared with a case where said user performs said specific driving operation after visually recognizing said displayed warning.

2. The vehicle control apparatus according to claim 1, wherein the controller is configured, in a period in which said collision risk object is present, to continue displaying said warning until a specific operation execution time point at which said user performs said specific driving operation after visually recognizing said displayed warning, and to terminate the display of said warning at said specific operation execution time point.

3. The vehicle control apparatus according to claim 2, wherein
said warning device includes a warning sound generating device configured to generate a warning sound, and
said controller is configured to:
cause said warning sound generating device to start generating said warning sound when it is determined that said collision risk object is present; and
cause said warning sound generating device to continue generating said warning sound regardless of whether or not said user performs said specific driving operation, as long as said collision risk object is present.

4. A vehicle control method comprising:
a step of determining whether or not a collision risk object that has a possibility of colliding with a vehicle is present;
a step of causing a warning display device of said vehicle to start displaying a warning when it is determined that a collision risk object is present; and
a step of terminating the display of said warning, when said collision risk object is no longer present or when a user of said vehicle performs a specific driving operation to reduce said collision risk after visually recognizing said displayed warning, whichever occurs earlier.

5. The vehicle control method according to claim 4 further comprising:
a step of causing a warning sound generating device of said vehicle to start generating a warning sound when it is determined that said collision risk object is present; and
a step of causing said warning sound generating device to continue generating said warning sound regardless of whether or not said user performs said specific driving operation, as long as said collision risk object is present.

6. A non-transitory computer-readable storage medium storing a program, said program comprising instructions which, when executed by a processor of a controller, cause said processor to perform:
a step of determining whether or not a collision risk object that has a possibility of colliding with a vehicle is present;
a step of causing a warning display device of said vehicle to start displaying a warning when it is determined that a collision risk object is present; and
a step of terminating the display of said warning, when said collision risk object is no longer present or when a user of said vehicle performs a specific driving operation to reduce said collision risk after visually recognizing said displayed warning, whichever occurs earlier.

7. The non-transitory computer-readable storage medium according to claim 6, wherein said instructions further cause said processor to perform:
a step of causing a warning sound generating device of said vehicle to start generating a warning sound when it is determined that said collision risk object is present; and
a step of causing said warning sound generating device to continue generating said warning sound regardless of whether or not said user performs said specific driving operation, as long as said collision risk object is present.
